(19) United States
(12) Patent Application Publication
(10) Pub. No.: US 2004/0008294 A1
(43) Pub. Date: Jan. 15, 2004

(54) Liquid crystal display device and method for manufacturing the same

(75) Inventor: Han-Chung Lai, Jungli City (TW)

Correspondence Address: Richard P. Berg, Esq., c/o LADAS & PARRY, 5670 Wilshire Boulevard, Suite 2100, Los Angeles, CA, 90036-5679, US

(73) Assignee: AU Optronics Corp.

(21) Appl. No.: 10/436,734

(22) Filed: May 12, 2003

(30) Foreign Application Priority Data
May 13, 2002 (TW) 91109928

(51) Int. Cl. G02F 1/136

(52) U.S. Cl. 349/43

(57) ABSTRACT

An active matrix substrate for an LCD device. The transparent substrate has gate lines, source lines, gate pads and source pads, a light-curable low-k (low dielectric constant) protection layer, and pixel electrodes located on the light-curable low-k protection layer. The horizontal gate lines, the vertical source lines, and thin film transistors (TFTs) disposed in the area where the gates lines and the source lines cross, are all located on the transparent substrate. The gate pads are located at the ends of the gate lines, and the source pads are located at the ends of the source lines. The light-curable low-k protection layer has contact openings exposing only the surfaces of drain electrodes of TFTs, and protects the source pads and the gate pads. Each pixel electrode formed on the light-curable low-k protection layer defines each pixel region, and the pixel electrodes overlap portions of the source lines and the gate lines.

### BACKGROUND OF THE INVENTION

1. Field of the Invention

The present invention relates to a liquid crystal display (LCD) device and the method for manufacturing the same, and more particularly, to a thin film transistor (TFT) LCD having high pixel aperture ratio, and the method for manufacturing the same.

2. Background of the Invention

FIG. 1 is a cross section showing an active matrix substrate of an LCD device, wherein A indicates a TFT area; B indicates a gate pad area; C indicates a source pad area; and a bonding pad area is composed of the gate pad area B and the source pad area C.

A first metal layer is formed on a glass substrate 11. After lithography and etching of the first metal layer, a gate line 13, a gate electrode 13a, a gate pad 13b and a source pad 13c are formed. The gate electrode 13a is formed at one corner of a pixel region, wherein the gate line 13 is connected to the gate electrode 13a, and the gate pad 13b is located at the end of the gate line 13.

A gate-insulating layer 15 is formed on the glass substrate 11 having the gate line 13, the gate electrode 13a, the gate pad 13b and the source pad 13c. A semiconductor layer 17 and a doped semiconductor layer 19 are formed on the gate-insulating layer 15 in the TFT area A. Thereafter, contact openings are formed in the gate-insulating layer 15, to expose the surfaces of the gate pad 13b and the source pad 13c.

A second metal layer is formed on the glass substrate 11 having the doped semiconductor layer 19. After lithography and etching of the second metal layer, a source electrode 23S, a drain electrode 23D, a source line 23, a gate pad 23b and a source pad 23c are formed. The source line 23 is connected to the source electrode 23S. The source electrode 23S contacts the semiconductor layer 17 and one side of the doped semiconductor layer 19, and the drain electrode 23D contacts the other side. The source pad 23c is located at the end of is the source line 23, and contacts the surface of the source pad 13c. The gate pad 23b contacts the surface of the gate pad 13b.

A silicon nitride protection layer 25 is formed on the glass substrate 11 having the source line 23, the gate pad 23b, the source pad 23c, the source electrode 23S and the drain electrode 23D, and is patterned to form contact openings to expose the surfaces of the drain electrode 23D, the gate pad 23b and the source pad 23c, which are desired to be electrically contacted.

In order to promote the pixel aperture ratio, before a pixel electrode is formed, forming a thick over-coating layer 27 to cover the surface of the silicon nitride protection layer 25 is proposed. Thus, capacitance between the pixel electrode and the electrically conductive material therebelow can be prevented, so that the pixel electrodes formed on the over coating layer can overlap portions of the address lines and the area of the pixel electrode can be expanded.

Thereafter, the over-coating layer 27 is patterned to form a contact opening to expose the surface of the drain electrode 23D to be electrically contacted. Further, since the over-coating layer 27 is acrylic and has poor adhesion with the silicon nitride protection layer 25, the gate pad area B and the source pad area C have to be totally exposed. Thus, if the gate pads (13b and 23b) and/or the source pads (13c and 23c) must be reworked, the internal elements covered by the over-coating layer 27 are not damaged during removal. However, such design increases the process complexity.

Thereafter, a transparent electrode is formed on the surface of the over-coating layer 27, and is patterned into a pixel electrode 29. An active matrix substrate is then formed, and subsequently, the assembly of the active matrix substrate and an upper substrate with liquid crystal therebetween is continuously performed.

### SUMMARY OF THE INVENTION

It is an object of the present invention to provide an active matrix substrate having high pixel aperture ratio that can be fabricated with simple manufacturing process and has lower difficulty level of reworking the bonding pad area.

The present invention provides an active matrix substrate of an LCD device, and the active matrix substrate comprises: a transparent substrate having gate lines, source lines, gate pads and source pads; a light-curable low-k (low dielectric constant) protection layer covering the aforementioned transparent substrate; and pixel electrodes located on the light-curable low-k protection layer. The horizontal gate lines, the vertical source lines, and thin film transistors (TFTs) disposed in the area where the gates lines and the source lines cross are located on the transparent substrate. The gate pads are located at the ends of the gate lines, the source pads are located at the ends of the source lines. The TFTs comprise drain electrodes connected to the pixel regions, source electrodes connected to the source lines, and gate electrodes connected to the gate lines. The light-curable low-k protection layer has contact openings only exposing the surfaces of drain electrodes of TFTs, and protects the source pads and the gate pads. Each pixel electrode formed on the light-curable low-k protection layer defines each pixel region, and the pixel electrodes overlap portions of the source lines and the gate lines.

The present invention provides a method for manufacturing the aforementioned active matrix substrate of an LCD device, and the method is briefly described as follows. A transparent substrate with gate lines, source lines, TFTs, gate pads, and source pads is provided.

Thereafter, a light-curable low-k protection layer is coated on the transparent substrate having source lines, source pads, gate lines and gate pads. After the light-curable low-k protection layer is exposed and developed, it is cured to protect the source pads and the gate pads, and contact openings exposing the surfaces of the drain electrodes are formed therein. Thereafter, pixel electrodes are formed on the light-curable low-k protection layer, wherein each pixel electrode defines each pixel region, and is connected to its corresponding drain electrode through its corresponding contact opening, the pixel electrodes overlapping portions of the source lines and the gate lines.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross section showing a TFT area (A), a gate pad area (B) and a source pad area (C) of an active matrix substrate, according to a conventional LCD device;

FIG. 2 is an electrical circuit diagram of a LCD device according to an embodiment of the present invention; and

FIG. 3A to FIG. 3C are cross sections showing a method for manufacturing the active matrix substrate of an LCD device, according to an embodiment of the present invention.

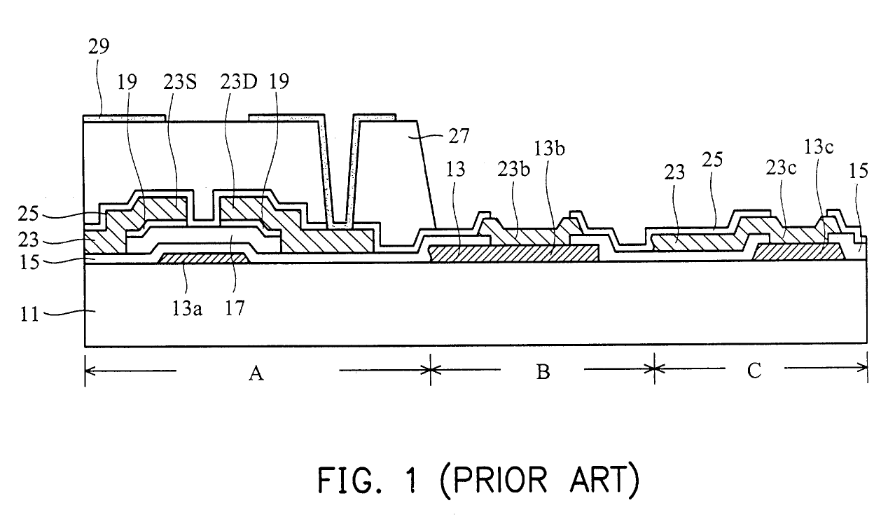

### DETAILED DESCRIPTION OF THE INVENTION

The present invention provides an active matrix substrate with high pixel aperture ratio that has a lower difficulty level of reworking the bonding pad area. The active matrix substrate comprises: a transparent substrate having gate lines, source lines, gate pads and source pads; a light-curable low-k protection layer covering the aforementioned transparent substrate; and pixel electrodes located on the light-curable low-k protection layer, wherein the light-curable low-k protection layer has contact openings exposing only the surfaces of the drain electrodes, and protects the source pads and the gate pads. Since the light-curable low-k protection layer has sufficient thickness to prevent the capacitance effect between the pixel electrodes and the electrically conductive material therebelow, the pixel electrodes can overlap portions of the address lines, i.e. the source lines and the gate lines.

According to the aforementioned transparent substrate, the gate lines are arranged horizontally and the source lines are arranged vertically, wherein the gate pads are disposed on the ends of the gate lines and the source pads are disposed on the ends of the source lines. TFTs used to control the pixel regions are disposed in the area where the gates lines and the source lines cross, i.e. one corner of each pixel region. The TFTs comprise drain electrodes connected to the pixel regions, source electrodes connected to source lines and gate electrodes connected to gate lines.

A detailed description of a structure and manufacturing method of the active matrix substrate is given below.

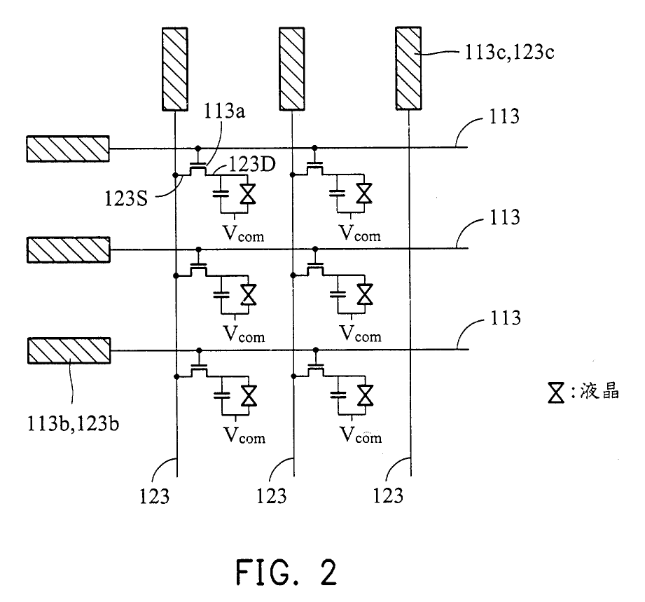

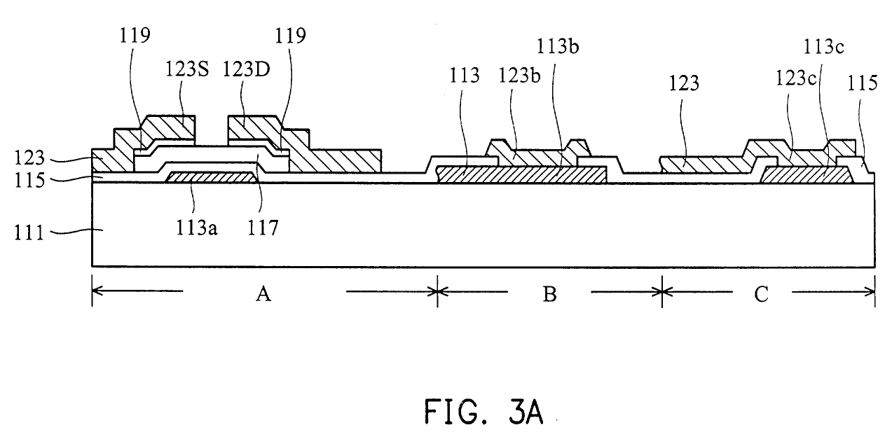

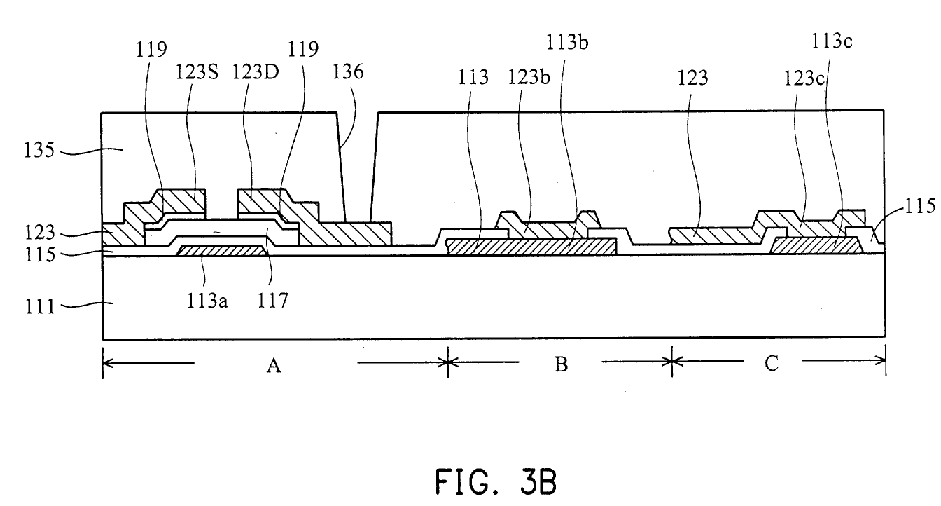

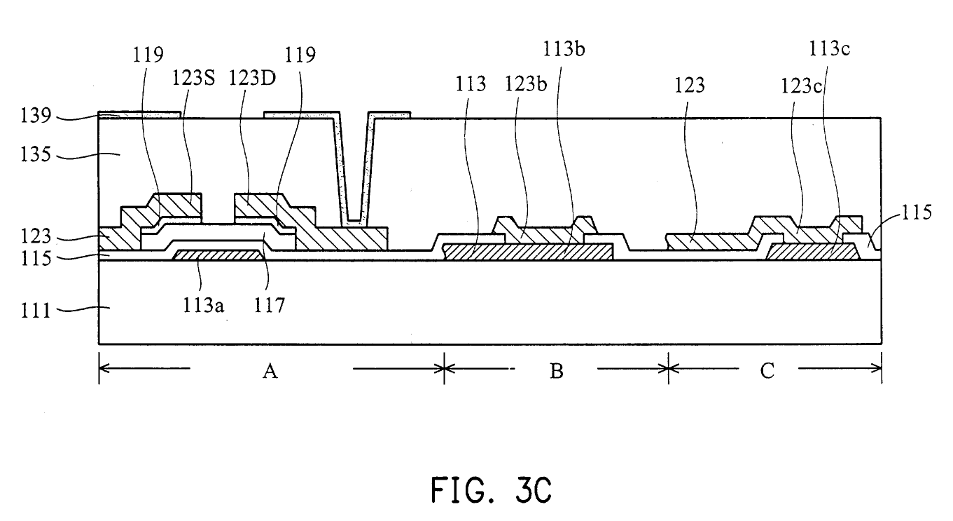

FIG. 2 is an electrical circuit diagram of a LCD device according to an embodiment of the present invention, and FIG. 3A to FIG. 3C are cross sections showing a method for manufacturing the active matrix substrate of an LCD device, according to the embodiment of the present invention. In the figures, A indicates a TFT area, B indicates a gate pad area, C indicates a source pad area, and a bonding pad area is composed of the gate pad area B and the source pad area C.

Please refer to FIG. 2 and FIG. 3. A transparent substrate 111, such as a glass substrate, is provided. A first metal layer, for example, aluminum or aluminum alloy, is formed on the transparent substrate 111. After lithography and etching of the first metal layer, gate lines 113, gate electrodes 113a, gate pads 113b and source pads 113c are formed. The gate electrodes 113a are formed at one corner of each pixel region. The gate electrodes 113a are connected to the gate lines 113, and the gate pads 113b are located at the end of the gate lines 113.

A gate-insulating layer 115, such as a silicon nitride or silicon oxide layer, is formed on the glass substrate 111 having the gate lines 113, the gate electrodes 113a and the gate pads 113b. A semiconductor layer 117 and a doped semiconductor layer 119 are formed on the gate-insulating layer 115 on the TFT area A. The semiconductor layer 117 can be an amorphous silicon layer, and the doped semiconductor layer 119 can be a doped silicon layer. Thereafter, contact openings are formed in the gate-insulating layer 115 to expose the surfaces of the source pads 113c located at the end of the source lines 123 and the gate pads 113b located at the end of the gate lines 113.

A second metal layer, such as a chromium or chromium alloy layer, is formed on the glass substrate 111 having the doped semiconductor layer 119. After lithography and etching the second metal layer, source electrodes 123S, drain electrodes 123D, source lines 123, gate pads 123b and source pads 123c are formed. While the step for defining the second metal layer is performed, the doped semiconductor layer 119 is defined again to form drain/source regions simultaneously. The source electrodes 123S are connected to the source lines 123, and the source electrodes 123S contact the semiconductor layer 117 and one side of the doped semiconductor 119 on the TFT area A, and the drain electrodes 123D contact the other side. The source pads 123c are located at the end of the source line 123, and contact the surface of the source pads 113c. The gate pads 123b contact the surface of the gate pads 113b located at the end of the gate lines 113.

Please refer to FIG. 3B. A low-k protection layer 135 is coated on the glass substrate 111 having the source electrodes 123S, the drain electrodes 123D, the source lines 123, the gate pads 123b and the source pads 123c, wherein the low-k protection layer 135 has characteristics of light curable and transparent, and its hardness is high enough after exposure and development that it can replace the conventionally used silicon nitride protection layer. The low-k protection layer 135 can be, for example, polysilazane, whose dielectric constant is about 2.5˜3.5. Moreover, since the dielectric constant of the low-k protection layer 135 is lower than that of the conventional silicon nitride protection layer (dielectric constant is about 7) and the conventional organic over-coating layer (dielectric constant is about 3.3), the thickness of the low-k protection layer 135 can thus be less than conventional layers. The thickness of the low-k protection layer 135 is about 2˜4 μm, therefore, it is able to provide reduced thickness for an LCD device.

The low-k protection layer 135 is exposed and developed to form contact openings 136, thereby exposing the surface of the drain electrodes 123D to be electrically contacted. It is worth noting that, after exposure and development, the low-k protection layer 135 still covers the entire bonding pad area (B and C), to protect the gate pads (113b and 123b) and the source pads (113c and 123c), thereby preventing those pads from oxidation before the upper substrate and liquid crystal are assembled.

Thereafter, please refer to FIG. 3C. A transparent electrode layer of, for example, indium tin oxide (ITO) is formed on the surface of the low-k protection layer 135, and then patterned to form pixel electrodes 139 in the TFT area A.

As mentioned above, since the pixel electrodes 139 are formed on the thicker low-k protection layer, capacitance between the pixel electrodes 139 and the electrically conductive material therebelow can be prevented, so that the coverage area of each pixel electrode 139 can be enlarged, thereby promoting the pixel aperture ratio.

Further, since the problem of poor adhesion between the conventional silicon nitride protection layer and the over-coating layer does not exist, the internal elements in the TFT area A are not damaged during removal for reworking the gate pads (113b and 123b) and/or the source pads (113c and 123c).

After the pixel electrode is formed, the active matrix substrate is completed, and the assembly of the upper substrate and liquid crystal can be subsequently performed.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A liquid crystal display (LCD) device having an active matrix substrate, comprising:
a transparent substrate having a plurality of horizontal gate lines, a plurality of vertical source lines and a plurality of thin film transistors (TFTs) disposed in the area where the gate lines and the source lines cross, each TFT controlling its corresponding pixel region, the TFTs comprising a plurality of drain electrodes connected to the pixel regions, a plurality of source electrodes connected to the source lines, and a plurality of gate electrodes connected to the gate lines, wherein a plurality of gate pads are connected to the ends of the gate lines, and a plurality of source pads are connected to the ends of the source lines;
a light-curable low-k (low dielectric constant) protection layer covering the transparent substrate having the source lines, the source pads, the gate lines and the gate pads, and protecting the source pads and the gate pads, the light-curable low-k protection layer having a plurality of contact openings exposing the surfaces of the drain electrodes; and
a plurality of pixel electrodes located on the light-curable low-k protection layer, wherein each pixel electrode defines each pixel region, and is connected to its corresponding drain electrode through its corresponding contact opening, the pixel electrodes overlapping portions of the source lines and the gate lines.

2. The liquid crystal display device of claim 1, wherein the light-curable low-k protection layer is polysilazane.

3. The liquid crystal display device of claim 1, wherein the light-curable low-k protection layer is 2 μm˜4 μm in thickness.

4. A method for manufacturing a liquid crystal display device having an active matrix substrate, comprising:
providing a transparent substrate with a plurality of horizontal gate lines, a plurality of vertical source lines and a plurality of thin film transistors (TFTs) disposed in the area where the gate lines and the source lines cross, each TFT controlling its corresponding pixel region, the TFTs comprising a plurality of drain electrodes connected to the pixel regions, a plurality of source electrodes connected to the source lines, and a plurality of gate electrodes connected to the gate lines, wherein a plurality of gate pads are connected to the ends of the gate lines, and a plurality of source pads are connected to the ends of the source lines;
coating a light-curable low-k protection layer on the transparent substrate having the source lines, the source pads, the gate lines and the gate pads;
exposing and developing the light-curable low-k protection layer to form a plurality of contact openings exposing the surfaces of the drain electrodes and cure the light-curable low-k protection layer to protect the source pads and the gate pads; and
forming a plurality of pixel electrodes on the light-curable low-k protection layer, wherein each pixel electrode defines each pixel region, and is connected to its corresponding drain electrode through its corresponding contact opening, the pixel electrodes overlapping portions of the source lines and the gate lines.

5. The method of claim 4, wherein the light-curable low-k protection layer is polysilazane.

6. The method of claim 4, wherein the light-curable low-k protection layer is 2˜4 μm in thickness.
